(19) United States
(12) Patent Application Publication
(10) Pub. No.: US 2022/0361690 A1
(43) Pub. Date: Nov. 17, 2022

(54) CHECKOUT HAVING VIRTUAL AUTOMATIC SHOPPING DIVIDER

(71) Applicant: Sergei Vasilevich CHERNENKO, BRYANSK (RU)

(72) Inventor: Sergei Vasilevich CHERNENKO, BRYANSK (RU)

(21) Appl. No.: 17/770,075

(22) PCT Filed: Apr. 24, 2020
(86) PCT No.: PCT/RU2020/050081

§ 371 Date: Apr. 19, 2022

(30) Foreign Application Priority Data
Oct. 21, 2019 (RU) 2019133218

(51) Int. Cl. A47F 9/04; G08B 5/36

(52) U.S. Cl. CPC A47F 9/04; G08B 5/36; B65G 15/00

(57) ABSTRACT

The invention relates to devices and methods for making purchases in supermarkets and other large commercial centres at checkouts and is aimed at simplifying and speeding up checkout operations, as well as at reducing the number of actions taken by a purchaser. A method for controlling the operation of a checkout equipped with a conveyor belt comprises the following steps, at which: —sections on the conveyor belt arranged between items of the purchasers next in line are designated manually or determined automatically; —virtual dividers are set on said sections by entering relevant coordinates in the control unit memory; —the location coordinates of the virtual separators are changed by the control unit in such a way that the virtual separators move synchronously with the conveyor belt.

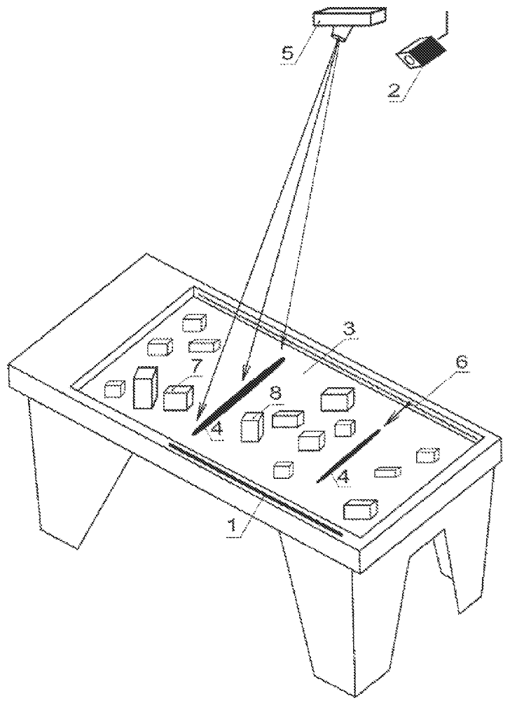

The invention relates to devices and methods for making purchases in supermarkets and other large commercial centres at checkouts. A checkout usually consists of a desk with a conveyor belt, a checkout lane with a cashier's seat and a tray for packing purchases.

Items are laid out by the purchaser on the conveyor belt, on which they gradually move to the checkout lane. While the items of the first purchaser are being processed by the cashier, the purchaser next in line puts his/her purchases on the belt, thus, the items of several purchasers appear on the conveyor at the same time.

A shopping divider in the form of a plastic bar to be put on the belt by the purchasers is usually used to separate the purchases of different customers from each other. The purchase paid for, the cashier passes said divider again to the beginning of the conveyor to the next purchaser.

Various shopping dividers are known from the prior art, for example from the patent DE202008003738U1, the divider is a rod-shaped body for dividing items on the conveyor, which has at least one display.

Another variant is presented in the patent DE102017009170A1, where another small conveyor for dividers is used to return the shopping divider to the beginning of the conveyor.

The disadvantages of the patents above are a need for additional mechanisms and actions that distract the attention of the cashier and the purchaser.

The objectives of this invention were to optimize the purchase process, simplify and speed up checkout operations, as well as reduce the number of actions taken by a purchaser. These tasks were solved by replacing the physical shopping divider with a virtual one (conditional, imaginary).

Embodiments of the invention are shown in the accompanying drawing.

The virtual divider assembly is controlled manually (by pressing a button, touching a sensor 1, by a gesture or other manipulation) and/or automatically using the software analysis of the video image from the camera 2.

The video image analysis program (computer vision) determines the locations of the item 7 farthest from the checkout lane of those laid out by the current purchaser on the belt and the item 8 closest to the checkout lane of those laid out by the next purchaser. Based on this data, between said items the control unit designates the location of the virtual (conditional) sopping divider.

The coordinates of the set virtual divider are entered into the control unit memory and are changed by it synchronously with the movement of the conveyor belt 3.

When the virtual divider reaches the control line by the checkout lane at the end of the conveyor, the control unit signalizes the system and the cashier that the items following this virtual divider on the conveyor belt should not be included into the current purchaser's receipt.

For the improved readability, a visual representation of the virtual divider is additionally output as an image 4 of any shape, generated by light sources. Generators of such an image may be a video projector 5, lamps, LEDs 6, laser beams. The visual representation of the virtual divider may be flat, three-dimensional (in the form of a hologram), it may contain inscriptions, moving objects and be accompanied by sound signals, that is, the image of the shopping divider is an augmented reality element.

Video cameras are usually installed over point-of-sale terminals for security; thus, the implementation of the described invention on the already operated checkouts is possible only by updating the software and integrating the signal from the video cameras into the control system. An embodiment of the shopping divider device can be in a single independent external module containing a video camera, a control unit, a video projector, network interfaces for data exchange. Depending on technical conditions and economic factors, it is possible to install one common control unit, communication unit and video signal processing unit on several local devices.

The light sources that generate the image can be located in any suitable place, overhead as a projector, sidewise as lamps along the conveyor 6 and on the belt itself.

The use of virtual dividers is an additional marketing tool to increase purchaser loyalty. In the case of using the variant without visualizing the virtual divider, purchasers will not notice the actions being taken, but the function of dividing purchases will be performed, and this solution will be more economical.

1. A method for controlling the operation of a checkout equipped with a conveyor belt, comprising the following steps, at which:
sections on the conveyor belt arranged between items of the purchasers next in line are designated manually (by pressing a button, touching a sensor, by gesture) or determined automatically (using software video data processing);
virtual shopping dividers are set on said sections by entering relevant coordinates in the control unit memory;
the location coordinates of the virtual dividers are changed by the control unit in such a way that the virtual dividers move synchronously with the conveyor belt.

2. The method of claim 1, wherein a visible representation of the virtual shopping divider is output as an image generated by a light source.

3. The method of claim 1, wherein when the virtual shopping divider reaches the control line, the control unit signalizes that the items behind this virtual divider on the conveyor belt do not belong to the current purchaser.
